(19) United States
(12) Patent Application Publication
(10) Pub. No.: US 2013/0106710 A1
(43) Pub. Date: May 2, 2013

(54) METHODS, APPARATUSES, AND COMPUTER PROGRAM PRODUCTS FOR ADJUSTING TOUCHSCREEN SENSITIVITY

(71) Applicant: Daniel L. Ashbrook, Sunnyvale, CA (US)

(72) Inventor: Daniel L. Ashbrook, Sunnyvale, CA (US)

(73) Assignee: Nokia Corporation, Espoo (FI)

(21) Appl. No.: 13/285,579

(22) Filed: Oct. 31, 2011

(51) Int. Cl. G06F 3/041

(52) U.S. Cl. 345/173

(57) ABSTRACT

Methods, apparatuses, and computer program products are herein provided for adjusting touchscreen sensitivity. A method may include detecting at least one triggering condition associated with a touchscreen being at least partially obstructed. The method may further include defining, by a processor, a sensitivity level for the touchscreen based at least in part on the at least one triggering condition. The method may further include causing updating of the touchscreen sensitivity based at least in part on the defined sensitivity level. Corresponding apparatuses and computer program products are also provided.

### TECHNOLOGICAL FIELD

Example embodiments of the present invention relate generally to user interface technology and, more particularly, relate to methods, apparatuses, and computer program products for adjusting touchscreen sensitivity.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Due to the increased functionality and small form factor, mobile computing devices are useful for users nearly anywhere. As such, users carry their mobile computing devices with them while they are on the go. In fact, mobile computing devices are often stored in pockets or purses throughout a user's day. Moreover, some functionality of the mobile computing devices can be maintained while the mobile computing device is stored in the user's pocket or purse.

### BRIEF SUMMARY

Sometimes a user may wish to interact with the mobile computing device that is currently stored, such as in the user's pocket. For example, a phone call may be received by the mobile computing device, which causes the device to emit a ringing noise. The user may want to silence the device, perhaps even without removing the device from its storage position. However, user interaction with a mobile computing device stored in a pocket may be difficult. In some cases, the sensitivity of the user interface, such as a touchscreen, may cause the attempted user interaction to not be recognized through the obstruction (e.g., the user's pocket, purse, etc.).

In situations where the mobile computing device is obstructed, a different touchscreen sensitivity may be desired. For example, a higher touchscreen sensitivity may allow attempted user interaction, such as a person attempting to provide user input to a touchscreen through their pocket (e.g., through a layer of fabric), to be recognized by the mobile computing device. As such, an example embodiment of the present invention provides methods, apparatuses, and computer program products for recognizing situations in which attempted user interaction may not be recognized, defining a desired touchscreen sensitivity to enable recognition of the user interaction, and adjusting the touchscreen sensitivity accordingly.

In one example embodiment, a method includes detecting at least one triggering condition associated with a touchscreen being at least partially obstructed. The method further includes defining, by a processor, a sensitivity level for the touchscreen based at least in part on the at least one triggering condition. The method further comprises causing updating of the touchscreen sensitivity based at least in part on the defined sensitivity level.

In some embodiments, detecting the at least one triggering condition comprises receiving input indicating that the touchscreen is at least partially obstructed and detecting at least one of an incoming call, playing of music, or a loss of a call. Additionally, in some embodiments, causing updating of the touchscreen sensitivity may include causing an increase in the touchscreen sensitivity.

In some embodiments, detecting the at least one triggering condition comprises receiving input from a sensor indicating that the touchscreen is at least partially obstructed by fabric. Additionally, in some embodiments, causing updating of the touchscreen sensitivity may include causing an increase in the touchscreen sensitivity.

In another example embodiment, an apparatus comprises at least one processor and at least one memory storing computer program code with the at least one memory and stored computer program code being configured, with the at least one processor, to cause the apparatus to detect at least one triggering condition associated with a touchscreen being at least partially obstructed. The at least one memory and stored computer program code are configured, with the at least one processor, to further cause the apparatus to define a sensitivity level for the touchscreen based at least in part on the at least one triggering condition. The at least one memory and stored computer program code are configured, with the at least one processor, to further cause the apparatus to cause updating of the touchscreen sensitivity based at least in part on the defined sensitivity level.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method comprising detecting at least one triggering condition associated with a touchscreen being at least partially obstructed. The method further includes defining a sensitivity level for the touchscreen based at least in part on the at least one triggering condition. The method further comprises causing updating of the touchscreen sensitivity based at least in part on the defined sensitivity level.

In another example embodiment, an apparatus is provided. The apparatus comprises means for detecting at least one triggering condition associated with a touchscreen being at least partially obstructed. The apparatus further comprises means for defining a sensitivity level for the touchscreen based at least in part on the at least one triggering condition. The apparatus further comprises means for causing updating of the touchscreen sensitivity based at least in part on the defined sensitivity level.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates a block diagram of an apparatus with a user interface according to an example embodiment of the present invention;

FIG. 2 is a schematic block diagram of a mobile terminal according to an example embodiment of the present invention;

FIG. 3 illustrates an example apparatus with a touchscreen, such as the apparatus illustrated in FIG. 1, in accordance with example embodiments of the present invention described herein;

FIG. 4 illustrates the apparatus of FIG. 3 disposed in a user's pocket, in accordance with example embodiments of the present invention described herein;

FIG. 5 illustrates the user attempting to interact with the apparatus of FIG. 3 while the apparatus is disposed in the user's pocket, in accordance with example embodiments of the present invention described herein;

FIGS. 6-11 illustrate example gestures for a user interacting with the apparatus of FIG. 3 while disposed in a pocket, in accordance with example embodiments of the present invention described herein;

FIG. 12 illustrates a flowchart according to an example method for adjusting sensitivity of a touchscreen, in accordance with example embodiments of the present invention described herein;

FIG. 13 illustrates a flowchart according to another example method for adjusting sensitivity of a touchscreen, in accordance with example embodiments of the present invention described herein; and

FIG. 14 illustrates a flowchart according to another example method for adjusting sensitivity of a touchscreen, in accordance with example embodiments of the present invention described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

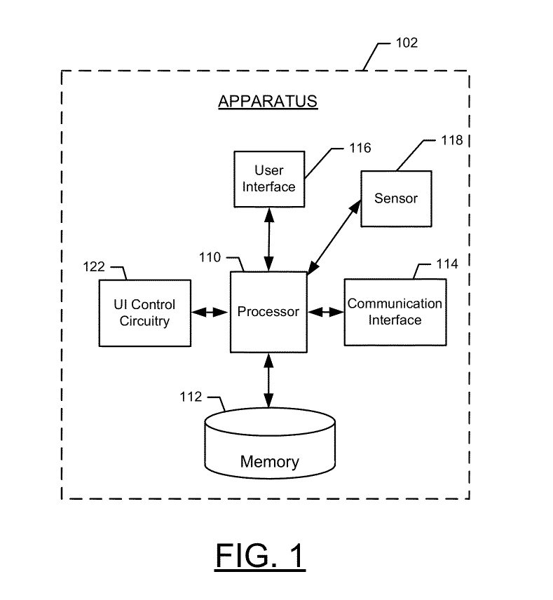

FIG. 1 illustrates a block diagram of an apparatus 102 for facilitating interaction with a user interface according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating interaction with a user interface, other configurations may also be used to implement embodiments of the present invention.

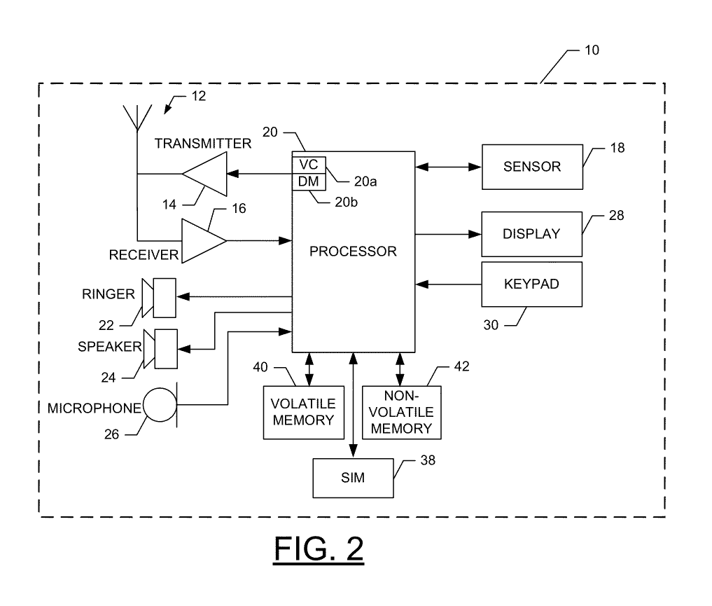

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a touch display capable of displaying a graphical user interface. In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, sensor 18, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, sensor 18, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), sensor 18, and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, sensor 118, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, sensor 118, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, and/or UI control circuitry 122, such as via a bus.

The sensor 118 may be in communication with the processor 110 and/or UI control circuitry 122. The sensor 118 may be configured to sense and/or detect input. In embodiments wherein the apparatus 102 is embodied as a mobile terminal 10, the sensor 118 may be embodied as or comprise the sensor 18 (shown in FIG. 2). The processor 110 and/or UI control circuitry 122 may be configured to receive input from the sensor 118 and determine that the apparatus 102 (and/or touchscreen) is at least partially obstructed. As such, the sensor 118 may receive input indicating that the apparatus 102 is at least partially obstructed. Similarly, the sensor 118 may receive input indicating that the apparatus 102 is disposed in a pocket/purse. In some embodiments, the sensor 118 may comprise an accelerometer, gyroscope, proximity sensor, and/or light sensor.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touchscreen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, sensor 118, and/or UI control circuitry 122, such as via a bus.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display (e.g., touchscreen). The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

As noted herein, the user interface 116 may have a touchscreen (e.g., touch display). In some embodiments, the touchscreen comprises a resistive touchscreen configured to receive input via direct contact. In other embodiments, the touchscreen comprises a capacitive touchscreen configured to detect a change in the touchscreen electrostatic field, thereby indicating input (e.g., a close user's finger may change the electrostatic field of a touchscreen).

In some embodiments, the touchscreens may have a sensitivity (e.g., touchscreen sensitivity) that determines what is detected or recognized as an input. For example, the apparatus 102, such as through the sensor 118 and/or UI control circuitry 122, may be configured to recognize a threshold magnitude of attempted interaction. In such embodiments, the touchscreen sensitivity may determine the threshold magnitude of user interaction that is recognized as input. In some embodiments, the touchscreen sensitivity may determine how much pressure must be applied to indicate an input.

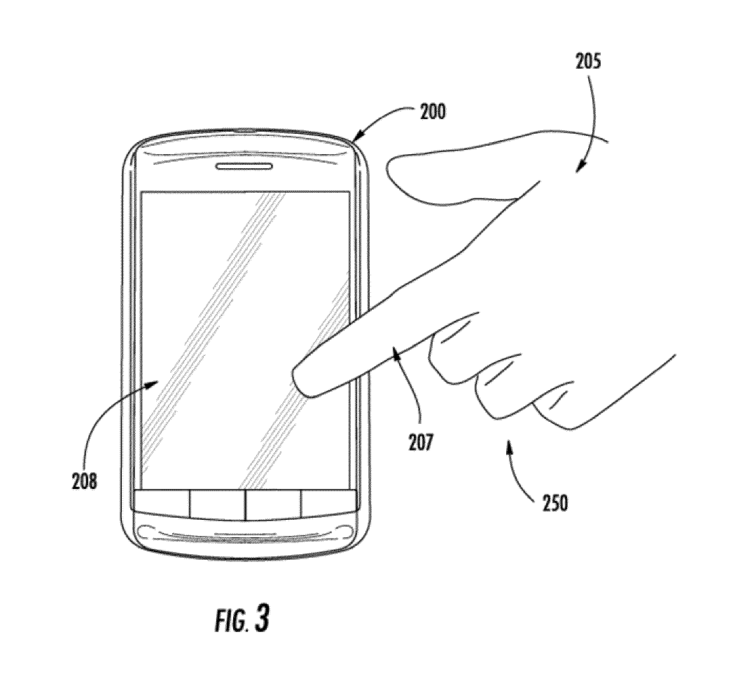

In some embodiments, the touchscreen may be a capacitive touchscreen. In such embodiments, the apparatus 102, such as through the UI control circuitry 122, may be configured to recognize a threshold change in capacitance. In such embodiments, the touchscreen sensitivity may determine the threshold change in capacitance that is recognized as input. In an example embodiment, with reference to FIG. 3, the apparatus 200 (e.g., apparatus 102) comprises a touchscreen 208. The touchscreen 208 has a sensitivity that determines if the gesture 250 by the user 205 will be recognized as input by the touchscreen 208. For example, in embodiments where the touchscreen 208 is a capacitive touchscreen, the touchscreen sensitivity determines the threshold capacitance required for recognition as input. In particular, placement of a user's finger near the touchscreen 208 causes a change in capacitance, as measured by the apparatus 200. In some cases, the closer the user's finger 207, the higher the change in capacitance. Likewise, the further away the user's finger 207, the lower the change in capacitance. As such, the touchscreen sensitivity determines how close the user's finger 207 needs to be positioned from the touchscreen 208 in order to register as input. The higher the touchscreen sensitivity, the further away the user's finger 207 can be from the touchscreen 208 to still register as input. Similarly, the lower the touchscreen sensitivity, the closer the user's finger 207 must be to the touchscreen 208.

In some embodiments, the touchscreen sensitivity may be pre-determined. In some circumstances, the pre-determined touchscreen sensitivity may define the touchscreen sensitivity for the apparatus independent of whether the touchscreen is obstructed. However, the pre-determined touchscreen sensitivity may be designed for a standard operation mode of the apparatus 102. For example, the touchscreen sensitivity may be pre-determined based on circumstances where the user's finger is able to directly contact the touchscreen 208 (e.g., a standard operating mode).

In some circumstances, the apparatus 200 and/or the touchscreen 208 may become at least partially obstructed. For example, with reference to FIG. 4, the apparatus 200 may be placed in the pocket 276 of the pants 278 of a user 270. Similarly, the apparatus 200 and/or touchscreen 208 may be placed inside a purse, clutch, backpack, or other storage means. In such circumstances, the touchscreen 208 may become obstructed from direct access, such as by a layer of fabric from the pocket 276.

Often times, a user may still wish to interact with the apparatus even when the apparatus is obstructed, such as when the apparatus is in the user's pocket. Though the apparatus 200 is at least partially obstructed, it may still be at least partially functional, such as being able to receive phone calls, play music, make phone calls, maintain phone calls, etc. For example, some apparatuses, such as apparatus 200, may be configured to remain in a user's pocket and still enable a phone call to be maintained (e.g., use with a Bluetooth-enabled, or other device). In some circumstances, a user may wish to provide instructions and/or input to the at least partially obstructed apparatus 200, such as silencing an incoming phone call, stopping the playing music, re-dialing a dropped call, etc.

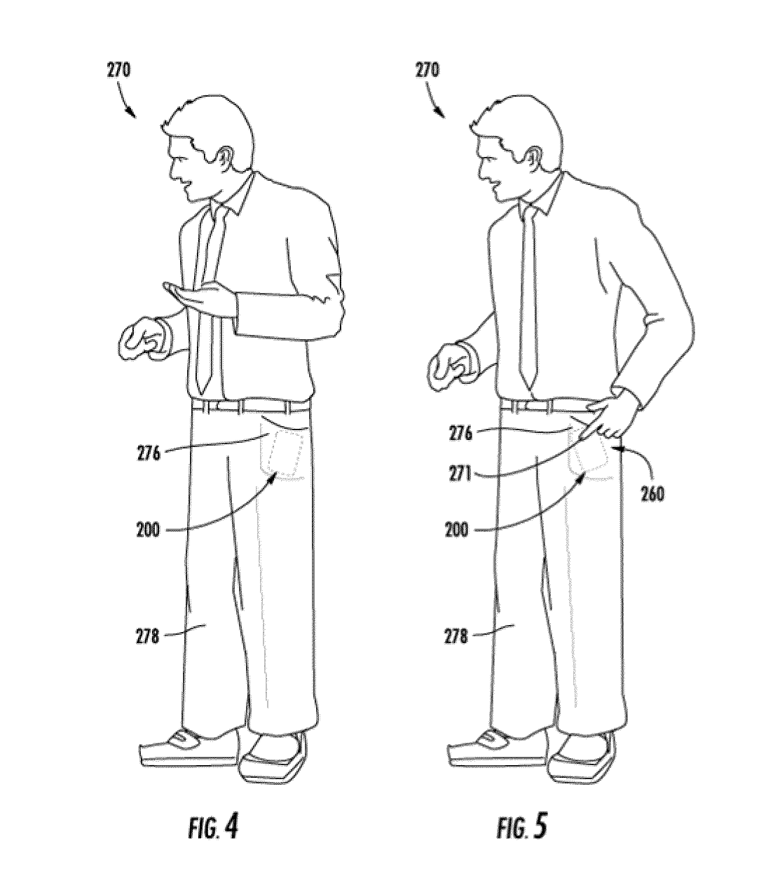

Interaction with an at least partially obstructed apparatus 102 may be difficult. As noted herein, the touchscreen of the apparatus may have a pre-determined sensitivity that determines what interaction will register as input. This pre-determined touchscreen sensitivity may be designed for use in an unobstructed circumstance (e.g., shown in FIG. 3). As such, when the touchscreen is obstructed, such as by a layer of fabric (e.g., shown in FIG. 4), attempted interaction with the touchscreen may not be recognized. For example, FIG. 5 illustrates a user 270 attempting to interact 260 with an apparatus 200 while the apparatus 200 is inside the user's pocket 276. The user 270 is attempting to perform user input 260 with their finger 271 by pressing on the touchscreen of the apparatus 200 through the pocket 276. However, the pre-determined touchscreen sensitivity of apparatus 200 may limit the recognition of any attempted interaction (e.g., the touchscreen may not recognize the attempted gesture 260 due to the layer of fabric from the pocket 276).

To account for this situation, in some embodiments, the apparatus 102 (e.g., the processor 110 and/or UI control circuitry 122) may be configured to update (e.g., adjust) the touchscreen sensitivity. In particular, in embodiments in which the touchscreen comprises a capacitive touchscreen, the touchscreen sensitivity may be updated. For example, the touchscreen sensitivity may be increased to allow user interaction from a distance further away from the touchscreen to be recognized as input. Additionally, the increase in touchscreen sensitivity could also enable a user interaction through an obstruction (e.g., a layer of fabric) to be recognized as an input. As such, the method and apparatuses of an example embodiment of the present invention may recognize circumstances in which an adjustment in the touchscreen sensitivity would be beneficial and update the touchscreen sensitivity accordingly. Such embodiments of the method and apparatuses would create a dynamic touchscreen that would enable user interaction with the apparatus in many circumstances, independent of whether the touchscreen is obstructed or unobstructed.

As is consistent with the above noted adjustability of the touchscreen, in some embodiments, the apparatus 102 may define different sensitivity levels that relate to different degrees of touchscreen sensitivity. In some embodiments, the higher the sensitivity level the higher the touchscreen sensitivity, which equates to the touchscreen being able to recognize a lower magnitude threshold of interaction, such as through obstructions (e.g., pockets, purses, etc.). Likewise, in such embodiments, the lower the sensitivity level the lower the touchscreen sensitivity, which equates to the touchscreen being limited to recognizing a higher magnitude threshold of interaction and, in some circumstances, failing to recognize some interaction of lower magnitude (e.g., through obstructions). Though the above described example indicates a direct correlation between a higher sensitivity level and higher touchscreen sensitivity, the method and apparatuses of an example embodiment of the present invention are not meant to be limited to this correlation, as other correlations may be used (e.g., a high sensitivity level equates to a low touchscreen sensitivity).

The apparatus 102 may be configured to detect at least one triggering condition. The at least one triggering condition may be defined to be any condition or any combination of conditions. In some embodiments, the triggering condition indicates a situation in which an adjustment in the touchscreen sensitivity would be beneficial. When referred to herein, “detecting at least one triggering condition” is not meant to be limited to the moment or near the moment the triggering condition first occurs as conditions may be ongoing or detected throughout the occurrence of the condition. For example, the method and apparatuses of an example embodiment of the present invention may detect when a touchscreen is first placed into a user's pocket and/or when the touchscreen is still positioned in the user's pocket. Example triggering conditions will be described herein, though these examples are not meant to be limiting, and are provided for explanatory purposes.

In some embodiments, the apparatus 102 may be configured to detect at least one triggering condition associated with a touchscreen being at least partially obstructed. Additionally or alternatively, the apparatus 102 may be configured to receive input from a sensor indicating that the touchscreen is at least partially obstructed. In some circumstances, the apparatus 102 may receive a signal from a sensor (e.g., sensor 118) that indicates that the touchscreen is covered, such as being in a pocket, purse, etc. For example, the sensor 118 may comprise a light sensor, and the sensor may detect an absence of light, which may indicate that the touchscreen is at least partially obstructed/covered. In another example, the sensor 118 may comprise an accelerometer, and the sensor may determine a certain amount or type of movement (e.g., walking), which may indicate that the touchscreen has been moved into a pocket/purse. Moreover, in another example embodiment where the sensor 118 comprises an accelerometer, the sensor may detect an orientation of the touchscreen that indicates that the touchscreen has been placed into a pocket/purse (e.g., with the user interface 116 facing a certain direction).

Additionally, in some embodiments, an additional sensor (e.g., a capacitive sensor) may be positioned on the side of the apparatus 102 opposite the touchscreen. In some embodiments, the additional sensor may be configured to sense a leg of a user. In such a case where the touchscreen is positioned in a user's pocket, the apparatus 102 may determine that the additional sensor is facing the user's leg, thereby indicating that the touchscreen is likely facing outwardly from the user's leg. Similarly, the apparatus 102 may be configured to determine when the touchscreen is not facing outwardly from the user's leg.

In some embodiments, the apparatus 102 may be configured to detect at least one triggering condition by detecting that the obstruction of the touchscreen has been removed. For example, the apparatus 102 may be configured to determine, based on received input (e.g., from sensor 118), that the apparatus 102 has been removed from a user's pocket.

In some embodiments, the apparatus 102 may be configured to detect at least one triggering condition by detecting at least one of an apparatus generated event or an apparatus communication event. Example apparatus generated events may include events initiated by the apparatus 102 (e.g., a calendar alarm, application notification, playing of a song, end of a song, etc.). Example apparatus communication events may include events associated with a communication function of the apparatus (e.g., receiving an incoming call, receiving a voicemail, loss of a call, etc.). In some embodiments, the apparatus 102 may be configured to detect at least one of an incoming call, playing of music, or a loss of a call. As noted herein, the apparatus 102 may be configured to perform many types of functions and/or operations, such as establishing, maintaining, or canceling phone calls and/or playing music. The apparatus 102 may be configured to detect the occurrence and/or ongoing occurrence of such conditions.

In some embodiments, the apparatus 102 may be configured to detect at least one triggering condition by receiving user input. In some circumstances, the apparatus 102 may be configured to receive user input associated with a calibration/adjustment mode for defining the touchscreen sensitivity. In particular, the user may provide user input that specifies the desired touchscreen sensitivity. As such, the apparatus 102 may detect such user input as a triggering condition. In other embodiments, the apparatus 102 may be configured to detect at least one triggering condition without receiving user input. In particular, in such embodiments, receiving of user input may not be a triggering condition.

In some embodiments, the apparatus 102 may be configured to detect at least one triggering condition by receiving user input when the touchscreen is operating at least partially in a power-save mode. In some embodiments, the apparatus may be operating in a power-save mode where at least some functionality of the apparatus is limited or reduced in order to preserve power (e.g., battery life). In such circumstances, the touchscreen may not be fully responsive to attempted user input. For example, the apparatus may be designed to disable the touchscreen in a power-save mode. Similarly, the apparatus may be designed to decrease the touchscreen sensitivity. In some embodiments, the apparatus 102 may be configured to detect that the apparatus is in a power-save mode and detect when a user attempts to provide input.

In some embodiments, the apparatus 102 may be configured to detect at least one triggering condition by detecting any number or combination of triggering conditions. For example, the previous example details an apparatus 102 detecting both a power-save mode and a user input, both of which are required to satisfy a respective triggering condition. Other combinations of triggering conditions are contemplated, some of which are described herein.

In some embodiments, the apparatus 102 is configured to detect at least one triggering condition associated with a touchscreen being at least partially obstructed and to detect at least one other triggering condition. Such triggering conditions may involve both detecting that the apparatus is at least partially obstructed (e.g., in a pocket) and detecting another triggering condition, such as any of the triggering conditions described herein.

In some example embodiments, the apparatus 102 is configured to detect at least one triggering condition associated with the touchscreen being at least partially obstructed and further detect at least one of an incoming call, playing of music, or a loss of a call. For example, the apparatus 102 could detect a triggering condition by receiving input from a light sensor indicating that that touchscreen is in a pocket and by receiving an incoming phone call. In such a circumstance, a user may have placed the apparatus in their pocket and may have received a phone call. In another example embodiment, the apparatus 102 could detect a triggering condition by receiving input from a proximity sensor indicating that the touchscreen is at least partially obstructed and by detecting loss of a phone call. In such a circumstance, a user may have initiated a phone call while the apparatus was in their pocket (such as with a Bluetooth-enabled, or similar device) and later the phone call could have been lost for some reason.

In some example embodiments, the apparatus 102 is configured to detect at least one triggering condition associated with the touchscreen being at least partially obstructed and further determine that user input is being attempted. For example, the apparatus 102 could detect a triggering condition by receiving input indicating that the touchscreen is in a pocket and by determining that a user is attempting user input. For example, in some circumstances, a user may be attempting to interact with the apparatus, however, the apparatus may be unable to determine the desired function to perform based on the attempted interaction. As a further example, an apparatus may be positioned in a user's pocket, the user may wish to initiate an application (e.g., skip the playing of a song) and, thus, attempt to press somewhere on the touchscreen. The apparatus may receive some indication of this user interaction, such as from sensor 118, UI control circuitry 122, and/or user interaction 116, but may be unable to determine the desired function associated with it. In such a circumstance, the apparatus could determine that user input is being attempted.

In some embodiments, the triggering condition may be associated with a desired touchscreen sensitivity. In particular, the at least one triggering condition may relate to a desired sensitivity level for the touchscreen based upon that specific triggering condition. For example, if the triggering condition is the detecting of a touchscreen being in a pocket and user input being attempted, a desired sensitivity level for the touchscreen may be a high touchscreen sensitivity level so as to enable recognition of the user input by the touchscreen through the pocket.

In such a regard, in some embodiments, the apparatus 102 may be configured to define a sensitivity level for the touchscreen based at least in part on the at least one triggering condition. For example, if the triggering condition indicates that a high touchscreen sensitivity would be desired, the apparatus 102 may define the sensitivity level to be high. In some cases, depending on the circumstance, this newly defined sensitivity level may be higher than a normal operating sensitivity level. In the opposite example, if the triggering condition indicates that a low touchscreen sensitivity would be desired, the apparatus 102 may define the sensitivity level to be low.

Some specific examples will be provided herein as they relate to previously described triggering conditions. However, such examples are not meant to limit embodiments of the present invention either in type of triggering condition or the defined sensitivity level based on the triggering condition. Moreover, more than one triggering condition may be detected and, thus, a defined sensitivity level may account for each and every detected triggering condition and/or combination of triggering conditions.

Though the following definitions of sensitivity levels provide examples with either a high sensitivity or low sensitivity, such delineations are not meant to be limiting. For example, a high sensitivity may refer to a sensitivity level that is higher than another sensitivity level, such as a current sensitivity level or a normal operating sensitivity level. Moreover, while definition of a sensitivity level may be referred to as high or low, the method and apparatuses of an example embodiment of the present invention may, additionally or alternatively, define a value, number, etc.

In some embodiments, the apparatus 102 may be configured to define a sensitivity level based at least in part on detecting input indicating that the touchscreen is at least partially obstructed. Additionally or alternatively, the apparatus 102 may be configured to define a sensitivity level based at least in part on receiving input from a sensor indicating that the touchscreen is at least partially obstructed (e.g., the touchscreen is covered, such as being in a pocket, purse, etc.). The definition of the sensitivity level desired for such a triggering condition can vary depending on the circumstances. For example, the apparatus 102 may define that a low sensitivity level is desired when detecting that the touchscreen is at least partially obstructed. In such a circumstance, it may be desirable to reduce accidental input from being received by the touchscreen, such as someone brushing by the pocket of the user. In another example, the apparatus 102 may determine that a high sensitivity level is desired when detecting that the touchscreen is at least partially obstructed. In such a circumstance, it may be desirable to have a higher touchscreen sensitivity to enable a user to provide input through the obstruction (e.g., a layer of fabric).

In some embodiments, the apparatus 102 may be configured to define a sensitivity level based at least in part on detecting that the obstruction of the touchscreen has been removed. For example, the apparatus 102 may be configured to define a sensitivity level based on determining that the apparatus 102 has been removed from a user's pocket. For example, the apparatus 102 may be configured to determine that a low sensitivity level is desired based on removal of the obstruction. In some embodiments, the apparatus 102 may be configured to define a sensitivity level that is lower than a sensitivity level that may have been defined based on the touchscreen being at least partially obstructed.

In some embodiments, the apparatus 102 may be configured to define a sensitivity level based at least in part on detecting at least one of an apparatus generated event or an apparatus communication event. In some embodiments, the apparatus 102 may be configured to define a sensitivity level based at least in part on detecting at least one of an incoming call, playing of music, or a loss of a call. For example, the apparatus 102 may determine that these conditions likely relate to a desire for a user to interact with the touchscreen. As such, the apparatus 102 may be configured to determine that a high sensitivity level is desired based on receiving an incoming call, playing music, or losing a call.

In some embodiments, the apparatus 102 may be configured to define a sensitivity level based at least in part on receiving user input. For example, the apparatus 102 may be configured to define a high sensitivity level when a first user input is received, as it may be likely that more user input will be subsequently attempted.

In some embodiments, the apparatus 102 may be configured to define a sensitivity level based at least in part on receiving user input when the touchscreen is operating at least partially in a power-save mode. In circumstances where the touchscreen is operating in a power-save mode, the touchscreen may not be fully responsive to attempted user input. Thus, the apparatus 102 may determine that a high sensitivity level may be desired as it may be likely that subsequent user input may follow.

In some embodiments, the apparatus 102 may be configured to define a sensitivity level based at least in part on detecting any number or combination of triggering conditions. In particular, the sensitivity level that is defined may account for a combination of different desired sensitivity levels when defining the desired sensitivity level based on all of the triggering conditions detected. For example, the previous example details an apparatus 102 detecting both a power-save mode and a user input. In such a circumstance, the apparatus 102 may define a sensitivity level that accounts for both the power-save mode and the user input. For example, the apparatus 102 may define a sensitivity level that is the average of a desired sensitivity level for receiving user input and a desired sensitivity level for the touchscreen being in power-save mode. In another example, the apparatus 102 may assign different weights to individual triggering conditions that would be taken into account when defining the sensitivity level for all the detected triggering conditions. For instance, the apparatus 102 may determine that receiving user input is more important than saving power and, thus, the apparatus 102 may define a sensitivity level to be high. On the other hand, the apparatus 102 may determine that saving power is more important than receiving user input and, thus, the apparatus 102 may define a sensitivity level to be low. As such, methods and apparatus of an example embodiment may utilize any type of determination or preference for defining a sensitivity level based at least on the detected triggering conditions.

Likewise, in some embodiments, the apparatus 102 may be configured to define a sensitivity level based at least in part on detecting at least one triggering condition associated with a touchscreen being at least partially obstructed and detecting at least one other triggering condition. In some example embodiments, the apparatus 102 is configured to detect at least one triggering condition associated with the touchscreen being at least partially obstructed and further detect at least one of an incoming call, playing of music, or a loss of a call. In such embodiments, the apparatus 102 could define a high sensitivity level when the touchscreen is detected as being obstructed and a phone call is received, music begins playing, or a phone call is lost. In such circumstances, it may be likely that a user will attempt to provide user input to the touchscreen through the obstruction and, thus, a high sensitivity level may be desired to enable recognition of the potential user input through the obstruction.

In some example embodiments, the apparatus 102 may be configured to define a sensitivity level based at least in part on detecting at least one triggering condition associated with the touchscreen being at least partially obstructed and further determine that user input is being attempted. For example, the apparatus 102 could define a high sensitivity level when the touchscreen is detected as being obstructed and attempted user input is detected. In such circumstances, it may be likely that a user will attempt to provide additional user input to the touchscreen through the obstruction.

In some embodiments, the apparatus 102 may be configured to determine the currently operating touchscreen sensitivity (e.g., the current touchscreen sensitivity). Additionally, the apparatus 102 may be configured to compare the current touchscreen sensitivity to the desired sensitivity level that was defined based at least in part on the triggering condition. Then, in some embodiments, in an instance in which the current sensitivity differs from the sensitivity level that has been defined (e.g., the desired sensitivity level based at least in part on the triggering condition), the apparatus 102 may be configured to cause an update and/or modification to the touchscreen sensitivity based on the defined sensitivity level. For example, the apparatus 102 may define a desired high sensitivity level when it detects that the touchscreen is obstructed and detects an incoming phone call. The apparatus 102 may also determine that the current touchscreen sensitivity is less than the desired sensitivity level, and in response, cause an update to the touchscreen sensitivity that increases the touchscreen sensitivity.

In some embodiments, the apparatus 102 may be configured to cause an update and/or modification to the touchscreen sensitivity based at least in part on the sensitivity level that is defined. For example, once the apparatus 102 defines a desired sensitivity level based on the triggering condition, the apparatus 102 may cause an update to the touchscreen sensitivity to reflect the desired sensitivity level. In some circumstances, the updating may involve increasing, decreasing, or maintaining the touchscreen sensitivity. For example, in an instance in which the apparatus 102 defines a desired high sensitivity level, the apparatus 102 may cause an update that increases the touchscreen sensitivity. Likewise, when the apparatus 102 defines a desired low sensitivity level, the apparatus 102 may cause an update that decreases the touchscreen sensitivity.

In an example embodiment, when the apparatus 102 detects a triggering condition associated with the touchscreen being at least partially obstructed, the apparatus 102 may define a desired low sensitivity level and, accordingly, the apparatus 102 may cause an update by decreasing the touchscreen sensitivity. On the other hand, however, in an instance in which the apparatus 102 detects a triggering condition associated with the touchscreen being at least partially obstructed, the apparatus 102 may define a desired high sensitivity level and, accordingly, the apparatus 102 may cause an update by increasing the touchscreen sensitivity.

In another example embodiment, when the apparatus 102 detects a triggering condition indicating that the obstruction has been removed from the touchscreen, the apparatus 102 may define a desired low sensitivity level and, accordingly, the apparatus 102 may cause an update by decreasing the touchscreen sensitivity.

In some embodiments, when the apparatus 102 detects a triggering condition of an apparatus generated event or an apparatus communication event, the apparatus 102 may define a desired high sensitivity level and, accordingly, the apparatus 102 may cause an update by increasing the touchscreen sensitivity. In another example embodiment, when the apparatus 102 detects a triggering condition of an incoming call, playing of music, or a loss of a call, the apparatus 102 may define a desired high sensitivity level and, accordingly, the apparatus 102 may cause an update by increasing the touchscreen sensitivity.

In yet another example embodiment, when the apparatus 102 detects a triggering condition of receiving user input, the apparatus 102 may define a desired high sensitivity level and, accordingly, the apparatus 102 may cause an update by increasing the touchscreen sensitivity. Likewise, in another example embodiment, when the apparatus 102 detects a triggering condition of receiving user input when the touchscreen is operating at least partially in a power-save mode, the apparatus 102 may define a desired high sensitivity level and, accordingly, the apparatus 102 may cause an update by increasing the touchscreen sensitivity.

In another example embodiment, when the apparatus 102 detects at least one triggering condition associated with a touchscreen being at least partially obstructed and further detects at least one of an incoming call, playing of music, or a loss of a call, the apparatus 102 may define a desired high sensitivity level and, accordingly, the apparatus 102 may cause an update by increasing the touchscreen sensitivity. Similarly, when the apparatus 102 detects at least one triggering condition associated with a touchscreen being at least partially obstructed and further determines that user input is being attempted, the apparatus 102 may define a desired high sensitivity level and, accordingly, the apparatus 102 may cause an update by increasing the touchscreen sensitivity.

The method and apparatuses of example embodiments of the present invention provide a number of advantages. For example, some embodiments of the present invention provide for easier user interaction with a touchscreen through obstructions, such as a layer of fabric from a pocket. In particular, in some embodiments, the apparatus 102 may recognize that the touchscreen is in a user's pocket and that the user is or will likely be attempting interaction with the touchscreen. Another advantage includes enabling user interaction that encounters less screen friction, as the user can interact with the touchscreen through cloth or fabric. Such an advantage may provide for faster and more easily executed user input (e.g., gestures).

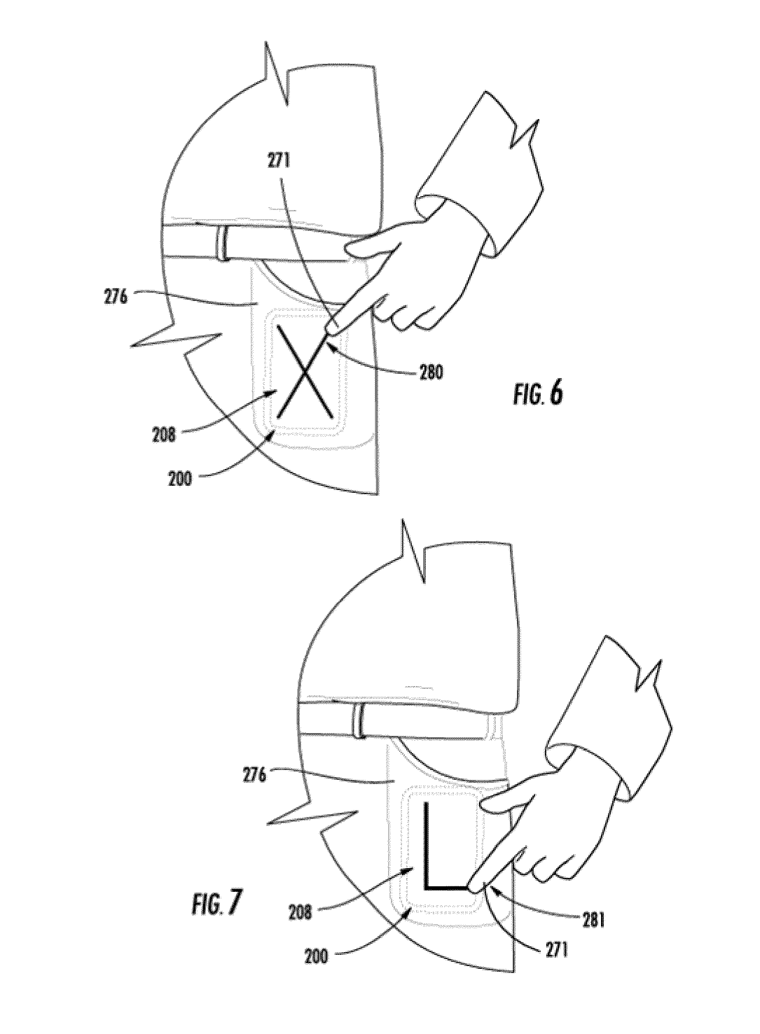

The method and apparatuses of some example embodiments of the present invention provide example gestures that the user may perform with the touchscreen through the user's pocket while the touchscreen is located inside the user's pocket. The apparatus 102 may be configured to recognize such gestures and perform an operation or function associated with the gesture. Example gestures are described below and reference FIGS. 6-11.

As noted herein, apparatuses, such as apparatus 200 shown in FIG. 6, may be temporarily stowed in a user's pocket 276. FIG. 6 illustrates an example gesture a user can perform with a touchscreen through their pocket or other obstruction. In some circumstances a phone call may be received by the apparatus 200, perhaps even at an inconvenient time. Often, receipt of a phone call causes the apparatus 200 to emit a noise (e.g., a ringing noise). A user may wish to silence the ringing of the apparatus 200 while keeping the apparatus 200 in their pocket 276. In such a situation, a user may perform a gesture 280 on the touchscreen 208 of the apparatus 200 through their pocket 276 to indicate that the apparatus 200 should silence (e.g., cease ringing). In the depicted embodiment, a user draws an “X” on the touchscreen 208 through the pocket 276 with their finger 271 to indicate that the apparatus 200 should silence the phone call.

FIG. 7 illustrates another example gesture a user can perform with a touchscreen through their pocket or other obstruction. In circumstances where a phone call is received by apparatus 200, a user can perform a gesture 281 to indicate to the apparatus 200 to have the caller receive a specific recorded message. In some embodiments, the recorded message may state that the call will be returned in just a few moments. In the depicted embodiment, a user draws an “L” on the touchscreen 208 with their finger 271 through the pocket 276 to indicate that the apparatus 200 should send the caller a certain recorded message. In some embodiments, the apparatus 200 may also silence the phone call in response to detecting the gesture 281.

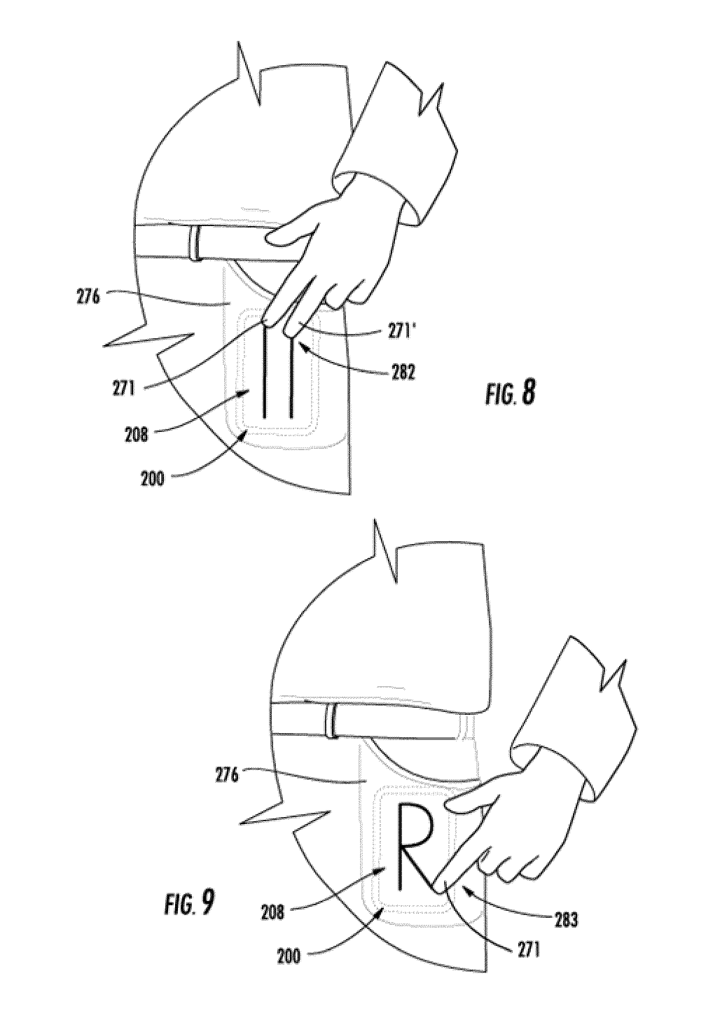

FIG. 8 illustrates another example gesture a user can perform with a touchscreen through their pocket or other obstruction. In some circumstances a user may be using functionality of apparatus 200 to listen to music, such as through headphones positioned in the user's ear and connected (e.g., wired or wirelessly) to the apparatus 200. Often, a loud noise from the user's surroundings may occur that disrupts the user's experience. For example, the user may be walking while listening to the music and a large garbage truck may pass by. In some embodiments, a user can perform a gesture 282 to indicate to the apparatus 200 to increase or decrease the volume of the music being played while the apparatus is still at least partially obstructed (e.g., in the user's pocket). In the depicted embodiment, a user, with two fingers 271, 271′, draws two straight lines upwardly (e.g., “II”) on the touchscreen 208 through the pocket 276 to indicate that the apparatus 200 should increase the volume of the music being played. Likewise, the user may simultaneously draw two straight lines downwardly on the touchscreen 208 through the pocket 276 to indicate that the apparatus 200 should decrease the volume of the music being played.

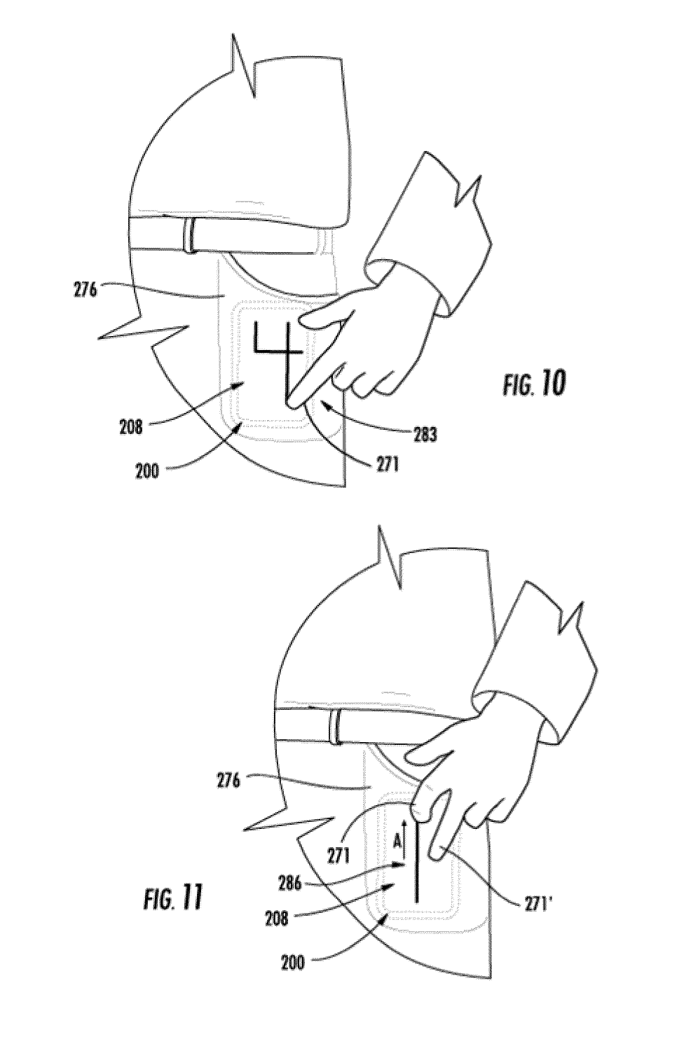

FIG. 9 illustrates another example gesture a user can perform with a touchscreen through their pocket or other obstruction. In some circumstances a user may be on a phone call using apparatus 200 and the phone call could be dropped and/or lost (e.g., the connection becomes disconnected). A user may wish to re-dial the number of the person they were just speaking with on the apparatus 200 while keeping the apparatus 200 in their pocket 276. In such a situation, a user may perform a gesture 283 on the touchscreen 208 of the apparatus 200 through their pocket 276 to indicate that the apparatus 200 should re-dial the number of the lost phone call. In the depicted embodiment, a user draws an “R” on the touchscreen 208 with their finger 271 through the pocket 276 to indicate that the apparatus 200 should re-dial the number of the lost phone call.

FIG. 10 illustrates another example gesture a user can perform with a touchscreen through their pocket or other obstruction. In some circumstances a user may wish to interact with an application or function through the apparatus 200. For example, a user may walk into a restaurant and they may want to “check in” to a Foursquare application. In such a situation, a user may perform a gesture 284 on the touchscreen 208 of the apparatus 200 through their pocket 276 to indicate that the apparatus 200 should perform a desired function with respect to the application. In the depicted embodiment, a user draws a “if” on the touchscreen 208 with their finger 271 through the pocket 276 to indicate that the apparatus 200 should check in via Foursquare.

FIG. 11 illustrates another example gesture a user can perform with a touchscreen, even through their pocket or other obstruction. In some circumstances a user may wish to interact with the at least partially obstructed touchscreen. In some embodiments, the user can provide a reference point while performing a gesture. In such a circumstance, the apparatus 200 can use the reference point (e.g., steady pressure from a user's finger) to define and/or adjust the touchscreen sensitivity for the user's additional gesture (e.g., input). For example, a user may perform a gesture 286 on the touchscreen 208 of the apparatus 200 through their pocket 276 to provide a reference point and an input. The user may perform the gesture 286 by positioning one finger on the touchscreen 208 (e.g., the reference point) and performing the additional input with the other finger. With reference to FIG. 11, a user positions one finger 271′ on the touchscreen 208 and moves the other finger 271 in an upward direction through the pocket 276 (e.g., along arrow “A”) to indicate the reference point to the apparatus 200 and indicate that the apparatus 200 should perform a function (e.g., scroll the displayed content).

The method and apparatuses of some example embodiments of the present invention are designed to provide user interaction with an apparatus through an obstruction, such as a pocket. While the above described gestures (e.g., gestures described with respect to FIGS. 6-11) are example gestures for a user to interact with a touchscreen through an obstruction, other gestures may be used. For example, in some embodiments, the touchscreen may only respond to gestures which use two fingers when the touchscreen is determined to be at least partially obstructed. Such an embodiment would avoid any accidental interaction, such as a person brushing by the pocket of the user.

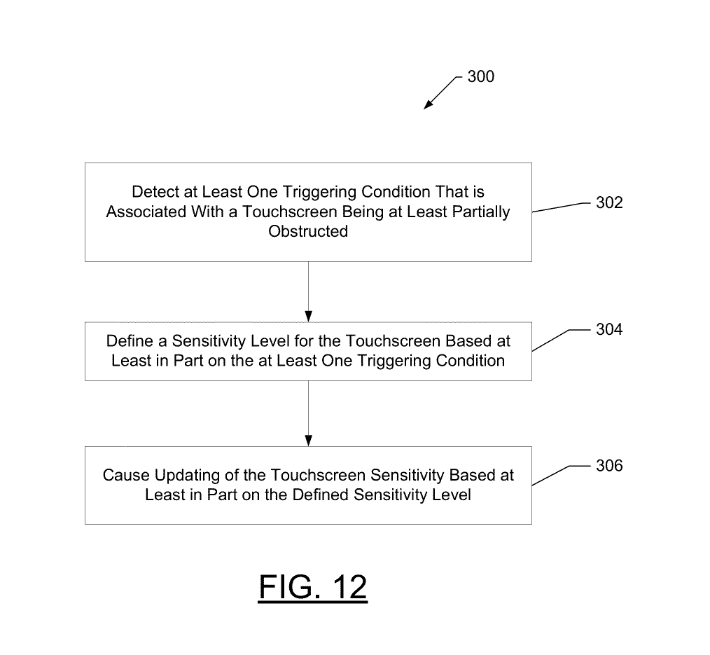

Embodiments of the present invention provide methods, apparatus and computer program products for adjusting touchscreen sensitivity. Various examples of the operations performed in accordance with embodiments of the present invention will now be provided with reference to FIGS. 12-14.

FIG. 12 illustrates a flowchart according to an example method for adjusting touchscreen sensitivity according to an example embodiment 300. The operations illustrated in and described with respect to FIG. 12 may, for example, be performed by, with the assistance of, and/or under the control of one or more of the processor 110, memory 112, communication interface 114, user interface 116, sensor 118, or UI control circuitry 122. Operation 302 may comprise detecting at least one triggering condition associated with a touchscreen being at least partially obstructed. The processor 110, user interface 116, sensor 118, and/or UI control circuitry 122 may, for example, provide means for performing operation 302. Operation 304 may comprise defining a sensitivity level for the touchscreen based at least in part on the at least one triggering condition. The processor 110 may, for example, provide means for performing operation 304. Operation 306 may comprise causing updating of the touchscreen sensitivity based at least in part on the defined sensitivity level. The processor 110, user interface 116, and/or UI control circuitry 122 may, for example, provide means for performing operation 306.

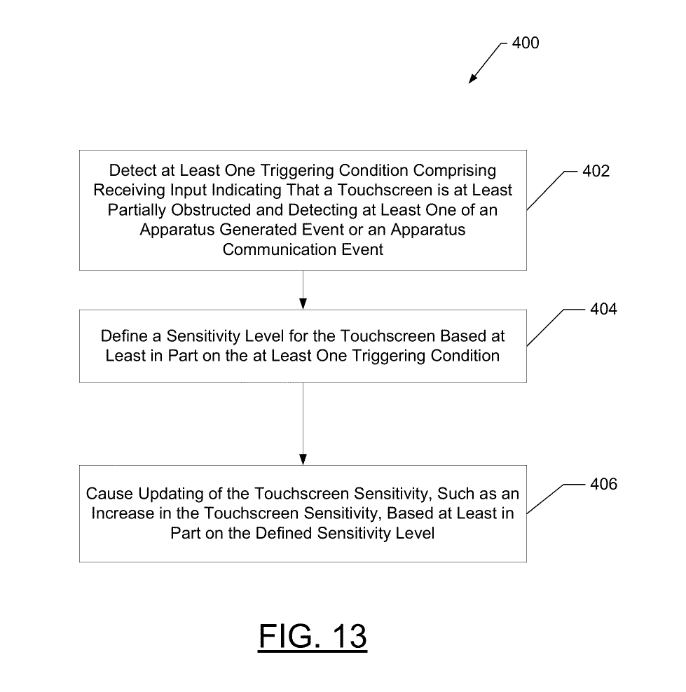

FIG. 13 illustrates a flowchart according to another example method for adjusting touchscreen sensitivity according to an example embodiment 400. The operations illustrated in and described with respect to FIG. 13 may, for example, be performed by, with the assistance of, and/or under the control of one or more of the processor 110, memory 112, communication interface 114, user interface 116, sensor 118, or UI control circuitry 122. Operation 402 may comprise detecting at least one triggering condition comprising receiving input indicating that a touchscreen is at least partially obstructed and detecting at least one of an apparatus generated event or an apparatus communication event. The processor 110, user interface 116, communication interface 114, sensor 118, and/or UI control circuitry 122 may, for example, provide means for performing operation 402. Operation 404 may comprise defining a sensitivity level for the touchscreen based at least in part on the at least one triggering condition. The processor 110 may, for example, provide means for performing operation 404. Operation 406 may comprise causing updating of the touchscreen sensitivity, such as an increase in the touchscreen sensitivity, based at least in part on the defined sensitivity level. The processor 110, user interface 116, and/or UI control circuitry 122 may, for example, provide means for performing operation 406.

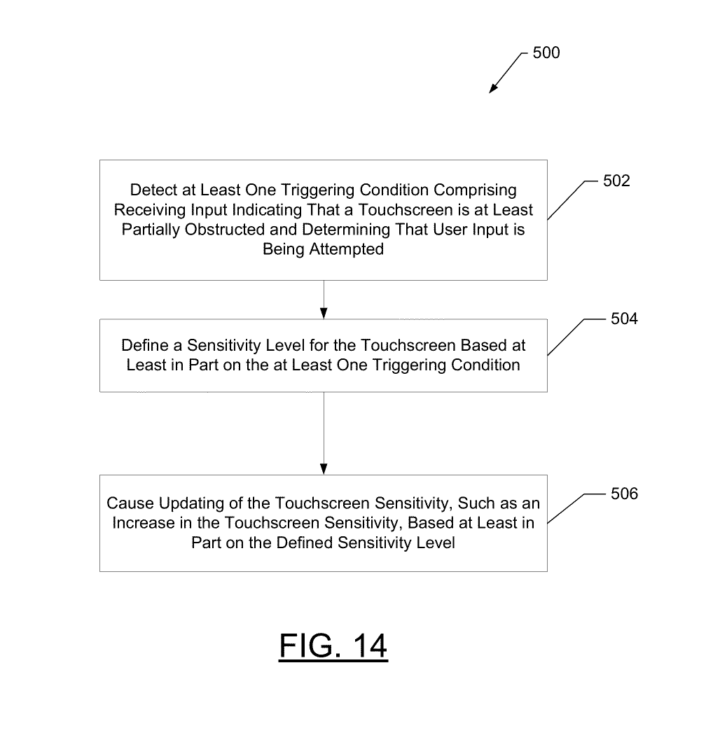

FIG. 14 illustrates a flowchart according to another example method for adjusting touchscreen sensitivity according to an example embodiment 500. The operations illustrated in and described with respect to FIG. 14 may, for example, be performed by, with the assistance of, and/or under the control of one or more of the processor 110, memory 112, communication interface 114, user interface 116, sensor 118, or UI control circuitry 122. Operation 502 may comprise detecting at least one triggering condition comprising receiving input indicating that a touchscreen is at least partially obstructed and determining that user input is being attempted. The processor 110, user interface 116, sensor 118, and/or UI control circuitry 122 may, for example, provide means for performing operation 502. Operation 504 may comprise defining a sensitivity level for the touchscreen based at least in part on the at least one triggering condition. The processor 110 may, for example, provide means for performing operation 504. Operation 506 may comprise causing updating of the touchscreen sensitivity, such as an increase in the touchscreen sensitivity, based at least in part on the defined sensitivity level. The processor 110, user interface 116, and/or UI control circuitry 122 may, for example, provide means for performing operation 506.

FIGS. 12-14 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
detecting at least one triggering condition associated with a touchscreen being at least partially obstructed;
defining, by a processor, a sensitivity level for the touchscreen based at least in part on the at least one triggering condition; and
causing updating of the touchscreen sensitivity based at least in part on the defined sensitivity level.

2. The method of claim 1, wherein detecting the at least one triggering condition comprises receiving input from a sensor indicating that the touchscreen is in a pocket.

3. The method of claim 2, wherein causing updating of the touchscreen sensitivity comprises causing an increase in the touchscreen sensitivity.

4. The method of claim 1, wherein detecting the at least one triggering condition comprises receiving input from a sensor indicating that the touchscreen has been removed from the pocket.

5. The method of claim 4, wherein causing updating of the touchscreen sensitivity comprises causing a decrease in the touchscreen sensitivity.

6. The method according to claim 1, wherein detecting the at least one triggering condition comprises receiving input indicating that the touchscreen is at least partially obstructed and detecting at least one of an apparatus generated event or an apparatus communication event.

7. The method according to claim 6, wherein detecting the at least one triggering condition of the apparatus generated event or the apparatus communication event comprises detecting at least one of incoming call, playing of music, or a loss of a call.

8. The method according to claim 7, wherein causing updating of the touchscreen sensitivity comprises causing an increase in the touchscreen sensitivity.

9. The method according to claim 1, wherein detecting the at least one triggering condition comprises receiving input indicating that the touchscreen is at least partially obstructed and determining that user input is being attempted.

10. The method according to claim 9, wherein causing updating of the touchscreen sensitivity comprises causing an increase in the touchscreen sensitivity.

11. An apparatus comprising a processor and a memory including computer program code, the memory and the computer program code configured to, with the processor, cause the apparatus to:
detect at least one triggering condition associated with a touchscreen being at least partially obstructed;
define a sensitivity level for the touchscreen based at least in part on the at least one triggering condition; and
cause updating of the touchscreen sensitivity based at least in part on the defined sensitivity level.

12. The apparatus of claim 11, wherein the memory and the computer program code are further configured to, with the processor, cause the apparatus to detect the at least one triggering condition by receiving input from a sensor indicating that the touchscreen is in a pocket.

13. The apparatus according to claim 12, wherein the memory and the computer program code are further configured to, with the processor, cause the apparatus to cause updating of the touchscreen sensitivity by causing a decrease in the touchscreen sensitivity.

14. The apparatus according to claim 11, wherein the memory and the computer program code are further configured to, with the processor, cause the apparatus to detect the at least one triggering condition by receiving input indicating that the touchscreen is at least partially obstructed and detecting at least one of an apparatus generated event or an apparatus communication event.

15. The apparatus according to claim 14, wherein the memory and the computer program code are further configured to, with the processor, cause the apparatus to detect the at least one triggering condition of the apparatus generated event or the apparatus communication event by detecting at least one of an incoming call, playing of music, or a loss of a call.

16. The apparatus according to claim 15, wherein the memory and the computer program code are further configured to, with the processor, cause the apparatus to cause updating of the touchscreen sensitivity by causing an increase in the touchscreen sensitivity.

17. The apparatus according to claim 11, wherein the memory and the computer program code are further configured to, with the processor, cause the apparatus to detect the at least one triggering condition by receiving input from a sensor indicating that the touchscreen is at least partially obstructed and by determining that user input is being attempted.

18. The apparatus according to claim 17, wherein the memory and the computer program code are further configured to, with the processor, cause the apparatus to cause updating of the touchscreen sensitivity by causing an increase in the touchscreen sensitivity.

19. Computer program product comprising a non-transitory computer readable medium having program code portions means stored thereon, the program code portions being a computer readable medium and configured when said program product is run on a computer or network device, to:
detect at least one triggering condition associated with a touchscreen being at least partially obstructed;
define a sensitivity level for the touchscreen based at least in part on the at least one triggering condition; and
cause updating of the touchscreen sensitivity based at least in part on the defined sensitivity level.

20. The computer program product of claim 19, wherein the program code portions are further configured when said program product is run on a computer of network device, to detect the at least one triggering condition receiving input indicating that the touchscreen is at least partially obstructed and receiving input from a sensor indicating that the touchscreen is in a pocket.
